(19) United States
(12) Patent Application Publication
(10) Pub. No.: US 2018/0113462 A1
(43) Pub. Date: Apr. 26, 2018

(54) POSITION-BASED SOFT STOP FOR A 3-AXIS GIMBAL

(71) Applicant: GoPro, Inc., San Mateo, CA (US)

(72) Inventors: Adam Misrack Fenn, San Francisco, CA (US); Pascal Gohl, Winterthur (CH); Thomas Gubler, Winterthur (CH); Sammy Omari, Zurich (CH); Nenad Uzunovic, San Mateo, CA (US)

(21) Appl. No.: 15/789,805

(22) Filed: Oct. 20, 2017

Related U.S. Application Data
(60) Provisional application No. 62/411,571, filed on Oct. 22, 2016.

(51) Int. Cl. G05D 1/00; B64D 47/08; B64C 39/02; F16M 13/02; F16M 11/12; F16M 11/20; H04N 5/225; H04N 5/232

(52) U.S. Cl. CPC G05D 1/0094; G05D 1/0011; B64D 47/08; B64C 39/024; F16M 13/02; B64C 2201/127; F16M 11/2028; H04N 5/2253; H04N 5/23296; B64C 2201/024; F16M 11/126

(57) ABSTRACT

An electronic gimbal is attached to a mounting platform and enables a mounted device such as a camera to rotate about three axes of rotation. The electronic gimbal may be configured with “soft stop” positions, past which the gimbal adjusts the target rotation to slow the rate of rotation as the motor approach mechanical stops.

### RELATED APPLICATIONS

This application claims the benefit of U.S. Provisional Application No. 62/411,571 filed on Oct. 22, 2016, which is incorporated by reference herein.

### BACKGROUND

### Field of Art

The disclosure generally relates to the field of gimbals and in particular a gimbal configured so that the motors do not reach their mechanical limits.

### Description of Art

The use of an electronic gimbal to stabilize or to set the orientation of a camera is known. A gimbal can be mounted to a platform such as an electronic vehicle. For example, a camera can be mounted via a gimbal to a remote control road vehicle or aerial vehicle to capture images as the vehicle is controlled remotely by a user. A gimbal can allow the recording of stable video even when the platform is unstable.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a functional block diagram illustrating an example configuration of a camera mounted on a gimbal which is, in turn, mounted to a mount platform.

FIG. 2 illustrates an example of a gimbal coupled to a remote controlled aerial vehicle.

FIGS. 3A and 3B illustrate an example of a gimbal and camera.

FIG. 4 illustrates a handheld grip coupled to a gimbal and camera.

FIG. 5 illustrates an example configuration of remote controlled aerial vehicle in communication with a remote controller.

FIG. 6 illustrates an example of a gimbal coupled to a rotating platform.

FIG. 7 illustrates an example of a gimbal coupled to a pole mount apparatus.

FIG. 8 is a block diagram of a gimbal control system, in accordance with an example embodiment.

FIG. 9A soft stops and mechanical stops for a motor of a gimbal.

FIG. 9B illustrates a motor rate adjustment in a soft stop region.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

An electronic gimbal is attached to a mounting platform and enables a mounted device such as a camera to rotate about three axes of rotation. An electronic gimbal may be configured with “soft stop” positions to prevent the gimbal motors from reaching their physical limits of rotation or to prevent the gimbal motors from positioning the camera in a way that components of the mounting platform (e.g., propellers of an aerial vehicle platform) restrict its field of view. The rate of rotation of a motor of a gimbal may be adjusted to move the gimbal motors out of soft stop regions.

In a particular embodiment, a gimbal comprises a gimbal arm a motor, a rotary encoder, and a gimbal controller. The motor is configured to rotate the gimbal arm about a rotational axis. The motor is mechanically constrained to rotate within a limited angle range. The rotary encoder detects a sensed motor angle of the motor. The gimbal controller controls the motor to rotate the gimbal arm based on a target orientation and the sensed motor angle. Particularly, the gimbal controller detects when the motor angle is within a soft stop region between a mechanical stop corresponding to a boundary of the limited angle range and a soft stop boundary at a predefined offset angle from the mechanical stop. The gimbal controller controls the motor to slow its rate of rotation when in the soft stop region and when the target orientation is in a direction of the mechanical stop relative to the sensed motor angle such that the motor is gradually stopped as it approaches the mechanical stop.

In an embodiment, the gimbal may be a component of an aerial vehicle platform or other mounting platform. Furthermore, a camera may be mounted of the gimbal.

### Example System Configuration

Turning now to Figure (FIG.) 1, which is a functional block diagram illustrating an example system framework. In this example, the gimbal system 160 includes a gimbal 100, a mount platform 110, a camera 120, a camera frame 130, a camera control connection 140 and a camera output connection 141, and a gimbal control system 150. The gimbal 100 includes a sensor unit 101 and a control logic unit 102. The mount platform 110 includes a camera controller 111, an image/video receiver 112, and a control logic unit 113. The camera 120 couples to the camera frame 130 which is mounted on the gimbal 100 which is, in turn, coupled to the mount platform 110. The coupling between the gimbal 100 and the mount platform 110 includes a mechanical coupling and a communication coupling. The camera control connection 140 and a camera output connection 141 connect the camera 120 to the mount platform 110 for communication coupling. The camera control connection 140 and a camera output connection 141 are composed of interconnecting electronic connections and data busses in the mount platform 110, gimbal 100, camera frame 130 and camera 120. The gimbal control system 150 controls the gimbal 100 using a combination of a sensor unit 101 and a control logic unit 102 in the gimbal 100 and a control logic unit 113 in the mount platform 110.

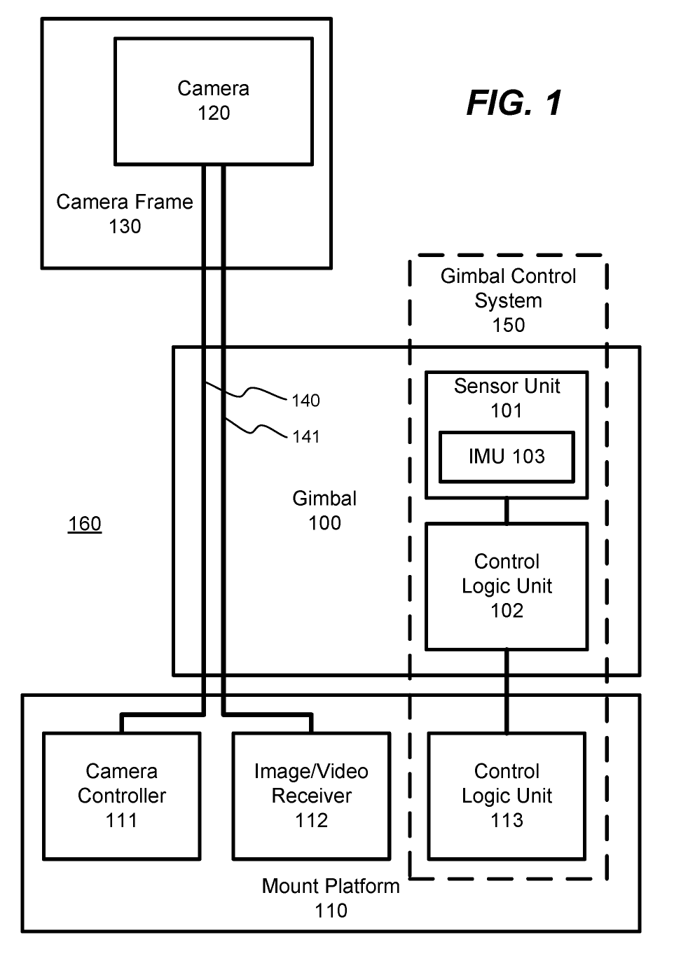

The camera 120 can include a camera body, one or more a camera lenses, various indicators on the camera body (such as LEDs, displays, and the like), various input mechanisms (such as buttons, switches, and touch-screen mechanisms), and electronics (e.g., imaging electronics, power electronics, metadata sensors, etc.) internal to the camera body for capturing images via the one or more lenses and/or performing other functions. The camera 120 can capture images and videos at various frame rates, resolutions, and compression rates. The camera 120 can be connected to the camera frame 130, which mechanically connects to the camera and physically connects to the gimbal 100. FIG. 1 depicts the camera frame 130 enclosing the camera 120 in accordance with some embodiments. In some embodiments, the camera frame 130 does not enclose the camera 120, but functions as a mount to which the camera 120 couples. Examples of mounts include a frame, an open box, or a plate. Alternately, the camera frame 130 can be omitted and the camera 120 can be directly attached to a camera mount which is part of the gimbal 100.

The gimbal 100 is, in some embodiments, an electronic three-axis gimbal which rotates a mounted object (e.g., a camera frame 130 connected to a camera 120) in space (e.g., pitch, roll, and yaw). In addition to providing part of an electronic connection between the camera 120 and the mount platform 110, the gimbal includes a sensor unit 101 and a control logic unit 102, both of which are part of a gimbal control system 150. The gimbal control system 150 detects the orientation of the gimbal 100 and camera 120, determines a preferred orientation of the camera 120, and controls the motors of the gimbal in order to re-orient the camera 120 to the preferred position.

The sensor unit 101 includes an inertial measurement unit (IMU) 103 which measures rotation, orientation, and acceleration using sensors, such as accelerometers, gyroscopes, and magnetometers. The IMU 103 may include a 3-dimentional linear accelerometer that measures the proper acceleration (i.e., acceleration relative to freefall in gravity) of the portion of the gimbal 100 where the accelerometer is located. The IMU 103 may also include a gyroscope for detecting rotation in 3-dimentions. The sensor unit 101 may also contain rotary encoders, which detect the angular position of the motors of the gimbal 100, and a magnetometer to detect a magnetic field, such as the earth's magnetic field. In some embodiments, the sensors of the sensor unit 101 are placed such as to provide location diversity. For example, a set of accelerometers and gyroscopes of the IMU 103 can be located near the camera 120 (e.g., near the connection to the camera frame 130) and a set of accelerometers and gyroscopes can be placed at the opposite end of the gimbal (e.g., near the connection to the mount platform 110). The outputs of these two sets of sensors can be used by the IMU 103 to calculate the orientation and rotational acceleration of the camera, which can then be output to the gimbal control system 150. In some embodiments, the sensor unit 101 is located on the mount platform 110. In some embodiments, the gimbal control system 150 receives data from sensors (e.g., an IMU 103) on the mount platform 110 and from the sensor unit 101 of the gimbal 100. In some embodiment the sensor unit 101 does not include the IMU 103 and instead receives position, acceleration, orientation, and/or angular velocity information from an IMU located on the camera 120.

The control logic unit 102 on the gimbal 100, the sensor unit 101, and the control logic unit 113 on the mount platform 110 constitute a gimbal control system 150. As discussed above, the IMU 103 of the sensor unit 101 produces an output indicative of the orientation, angular velocity, and acceleration of at least one point on the gimbal 100. The control logic unit 102 on the gimbal 100 receives the output of the sensor unit 101. In some embodiments, the control logic unit 113 on the mount platform 110 receives the output of the sensor unit 101 instead of, or in addition to the control logic unit 102 on the gimbal 100. The combination of the two control logic units 102 and 113 implement a control algorithm which control the motors of the gimbal 100 to adjust the orientation of the mounted object to a preferred position. Thus, the gimbal control system 150 has the effect of detecting and correcting deviations from the preferred orientation for the mounted object. Control algorithms suitable for this purpose are known to those skilled in the art.

The particular configuration of the two control portions of the gimbal control system 150 will vary between embodiments. In some embodiments, the control logic unit 102 on the gimbal 100 implements the entire control algorithm and the control logic unit 113 of the mount platform 110 provides parameters which dictate how the control algorithm is implemented. These parameters can be transmitted to the gimbal 100 when the gimbal 100 is originally connected to the mount platform 110. These parameters can include a range of allowable angles for each motor of the gimbal 100, the orientation, with respect to gravity, that each motor should correspond to, a desired angle for at least one of the three spacial axes with which the mounted object should be oriented, and parameters to account for different mass distributions of different cameras. In another embodiment, the control logic unit 113 on the mount platform 110 performs most of the calculations for the control algorithm and the control logic unit 102 on the gimbal 100 includes proportional-integral-derivative controllers (PID controllers). The PID controllers' setpoints (i.e., the points of homeostasis which the PID controllers target) can be controlled by the control logic unit 113 of the mount platform 110. The setpoints can correspond to motor orientations or to the orientation of the mounted object. In some embodiments, either the control logic unit 102 of the gimbal 100 or the control logic unit 113 or the mount platform 110 is omitted the control algorithm is implemented entirely by the other control logic unit.

The mount platform 110 is shown connected to the gimbal 100. The mount platform 110 may be, for example, an aerial vehicle, a handheld grip, a land vehicle, a rotating mount, a pole mount, or a generic mount, each of which can itself be attached to a variety of other platforms. The gimbal 100 may be capable of removably coupling to a variety of different mount platforms. The mount platform 110 can include a camera controller 111, an image/video receiver 112, and the aforementioned control logic unit 113. The image/video receiver 112 can receive content (e.g., images captured by the camera 120 or video currently being captured by the camera 120). The image/video receiver 112 can store the received content on a non-volatile memory in the mount platform 110. The image/video receiver 112 can also transmit the content to another device. In some embodiments, the mount platform 110 transmits the video currently being captured to a remote controller, with which a user controls the movement of the mount platform 110, via a wireless communication network.

The gimbal 100 can be coupled the camera 120 and to the mount platform 110 in such a way that the mount platform 110 (e.g., a remote controlled aerial vehicle or a hand grip) can generate commands via a camera controller 111 and send the commands to the camera 120. Commands can include a command to toggle the power the camera 120, a command to begin recording video, a command to stop recording video, a command to take a picture, a command to take a burst of pictures, a command to set the frame rate at which a video is recording, or a command to set the picture or video resolution. Another command that can be sent from the mount platform 110 through the gimbal 100 to the camera 120 can be a command to include a metadata tag in a recorded video or in a set of pictures. In this example configuration, the metadata tag contains information such as a geographical location or a time. For example, a mount platform 110 can send a command through the gimbal 100 to record a metadata tag while the camera 120 is recording a video. When the recorded video is later played, certain media players may be configured to display an icon or some other indicator in association with the time at which the command to record the metadata tag was sent. For example, a media player might display a visual queue, such as an icon, along a video timeline, wherein the position of the visual queue along the timeline is indicative of the time. The metadata tag can also instruct the camera 120 to record a location, which can be obtained via a GPS receiver (Global Positioning Satellite receiver) located on the mount platform 110 or the camera 120, in a recorded video. Upon playback of the video, the metadata can be used to map a geographical location to the time in a video at which the metadata tag was added to the recording.

Signals, such as a command originating from the camera controller 111 or video content captured by a camera 120 can be transmitted through electronic connections which run through the gimbal 100. In some embodiments, telemetric data from a telemetric subsystem of the mount platform 110 can be sent to the camera 120 to associate with video captured and stored on the camera 120. A camera control connection 140 can connect the camera controller 111 module to the camera 120 and a camera output connection 141 can allow the camera 120 to transmit video content or pictures to the image/video receiver 112. The connections can also provide power to the camera 120, from a battery located on the mount platform 110. The battery of the mount platform 110 can also power the gimbal 100. In an alternate embodiment, the gimbal 100 contains a battery, which can provide power to the camera 120. The connections between the camera 120 and the gimbal 100 can run through the gimbal 100 and the camera frame 130. The connection between the camera 120 and the mount platform 110 can constitute a daisy chain or multidrop topology in which the gimbal 100 and camera frame 130 act as buses. The connections can implement various protocols such as HDMI (High-Definition Multimedia Interface), USB (Universal Serial Bus), or Ethernet protocols to transmit data. In one embodiment, the camera output connection 141 transmits video data from the camera 120 via the HDMI protocol connection and the camera control connection 140 is a USB connection. In some embodiments, the connection between the camera 120 and the mount platform 110 is internal to the gimbal 100.

### Example Aerial Vehicle Configuration

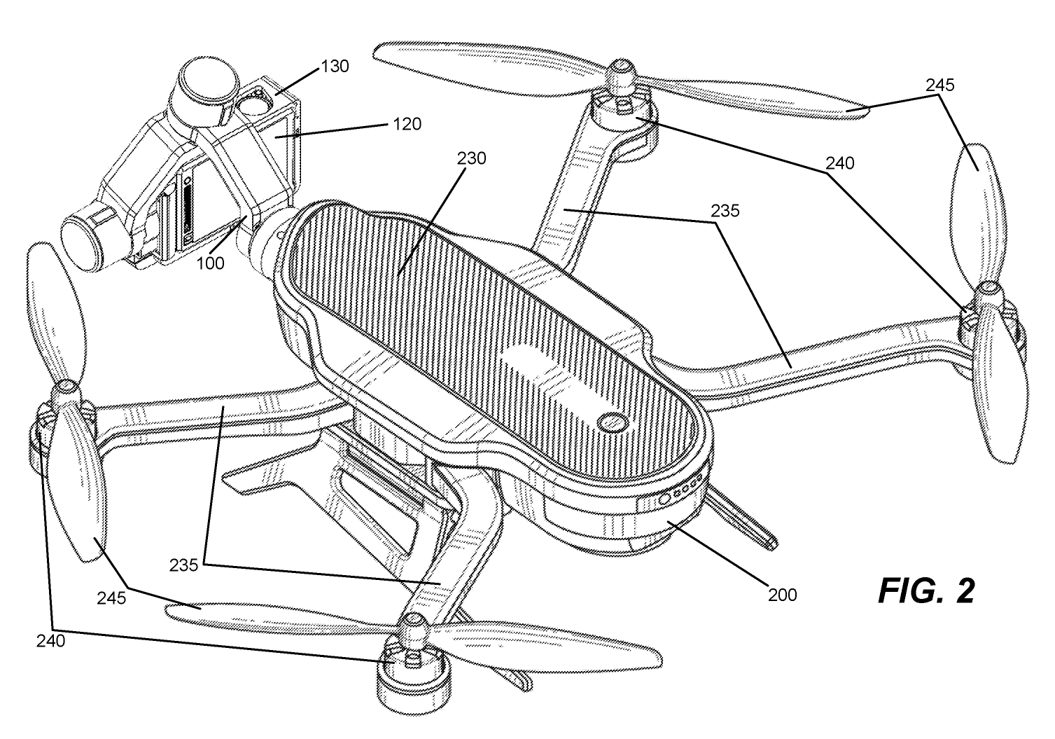

FIG. 2 illustrates an embodiment in which the mount platform 110 is an aerial vehicle 200. More specifically, the mount platform 110 in this example is a quadcopter (i.e., a helicopter with four rotors). The aerial vehicle 200 in this example includes housing 230 which encloses a payload (e.g., electronics, storage media, and/or camera), four arms 235, four rotors 240, and four propellers 245. Each arm 235 mechanically couples with a rotor 240, which in turn couples with a propeller 245 to create a rotary assembly. When the rotary assembly is operational, all the propellers 245 at appropriate speeds to allow the aerial vehicle 200 lift (take off), land, hover, and move (forward, backward) in flight. Modulation of the power supplied to each of the rotors 240 can control the trajectory and torque on the aerial vehicle 200.

A gimbal 100 is shown coupled to the aerial vehicle 200. A camera 120 is shown enclosed in a removable camera frame 130 which is attached the gimbal 100. The gimbal 100 is coupled to the housing 230 of the aerial vehicle 200 through a removable coupling mechanism that mates with a reciprocal mechanism on the aerial vehicle 200 having mechanical and communicative capabilities. The gimbal 100 can be removed from the aerial vehicle 200. The gimbal 100 can also be removably attached to a variety of other mount platforms, such as a handheld grip, a ground vehicle, and a generic mount, which can itself be attached to a variety of platforms. In some embodiments, the gimbal 100 can be attached or removed from a mount platform 110 without the use of tools.

### Example Gimbal

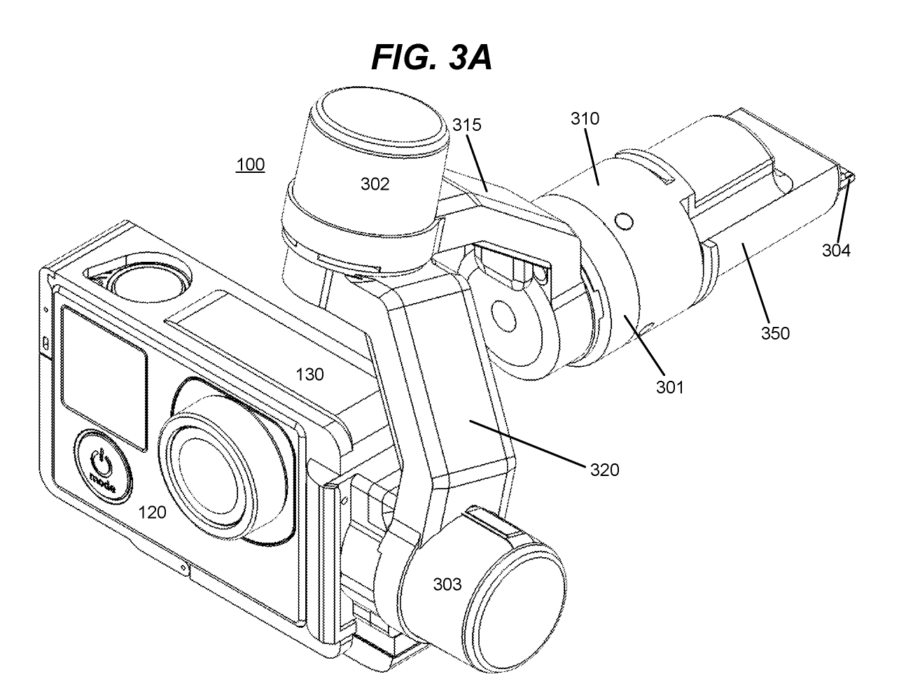

FIGS. 3A and 3B, illustrate an example embodiment of the gimbal 100 attached to a removable camera frame 130, which itself is attached to a camera 120. The example gimbal 100 includes a base arm 310, a middle arm 315, a mount arm 320, a first motor 301, a second motor 302, and a third motor 303. Each of the motors 301, 302, 303 can have an associated rotary encoder, which will detect the rotation of the axel of the motor. Each rotary encoder can be part of the sensor unit 101. The base arm 310 is configured to include a mechanical attachment portion 350 at a first end that allows the gimbal 100 to securely attach a reciprocal component on another mount platform (e.g., an aerial vehicle 200, a ground vehicle, or a handheld grip), and also be removable. The base arm 310 also includes the first motor 301. The base arm 310 couples to the middle arm 315. A first end of the middle arm 315 couples to the base arm 310, and a second end by the first motor 301. A second end of the middle arm 315 is where the second motor 302 is coupled. A first end of the mount arm 320 is coupled with the second end of the middle arm 315 at the second motor 302. The second end of the mount arm 320 is where the third motor 303 is coupled as well as the camera frame 130. Within the camera frame 130, the camera 120 is removably secured.

The gimbal 100 is configured to allow for rotation of a mounted object in space. In the embodiment depicted in FIG. 3A and FIG. 3B, the mounted object is a camera 120 to which the gimbal 100 is mechanically coupled. The gimbal 100 allows for the camera 120 to maintain a particular orientation in space so that it remains relatively steady as the platform to which it is attached moves (e.g., as an aerial vehicle 200 tilts or turns during flight). As is typically the case for electronic gimbals, the gimbal 100 has three motors, each of which rotates the mounted object (e.g., the camera 120) about a specific axis of rotation. Herein, for ease of discussion, the motors are numbered by their proximity to the mount platform 110 (i.e., the first motor 301, the second motor 302, and the third motor 303).

The gimbal control system 150 controls the three motors 301, 302, and 303. After detecting the current orientation of the mounted object, via the sensor unit 101, the gimbal control system 150 determines a preferred orientation along each of the three axes of rotation (i.e., yaw, pitch, and roll). The preferred orientation will be used by the gimbal control system 150 compute a rotation for each motor in order to move the camera 120 to the preferred orientation or keep the camera 120 in the preferred orientation. In one embodiment, the gimbal control system 150 has a preferred orientation that is configured by the user. The user can input the preferred orientation of the camera 120 with a remote controller which sends the preferred orientation for the camera 120 to the aerial vehicle 200 through a wireless network, which then provides the preferred orientation to the gimbal control system 150. In some embodiments the preferred orientation can be defined relative to the ground, so that the yaw, pitch, and roll of the camera remain constant relative to the ground. In some embodiments, certain axes of rotation can be unfixed. That is, an unfixed axis of rotation is not corrected by the gimbal control system 150, but rather remains constant relative to the aerial vehicle 200. For example, the yaw of the camera 120 can be unfixed, while the roll and the pitch are fixed. In this case, if the yaw of the aerial vehicle 200 changes the yaw of the camera 120 will likewise change, but the roll and the pitch of the camera 120 will remain constant despite roll and pitch rotations of the aerial vehicle 200. In some embodiments, bounds of rotation can be defined which limit the rotation along certain axes relative to the connection between the gimbal 100 and the mount platform 110. For example, if αₘₐₓ and αₘᵢₙ are the relative maximum and minimum values for the yaw of the camera 120 relative to the mount platform 110, then if the aerial vehicle 200 is oriented at a yaw of αₐᵥ degrees, the preferred yaw of the camera α_{c} must be chosen by the gimbal control system 150 so that the angle α_{c} is between the angles (αₘᵢₙ+αₐᵥ) and (αₘₐₓ+αₐᵥ). Similar maximum and minimum values can be defined for the pitch and roll. The maximum and minimum for each of the relative angles can be defined such that the viewing angle of the camera 120 is not obstructed by the gimbal 100 and/or the mount platform 110 at any angle within the valid bounds. In some embodiments, the preferred orientation of the camera 120 is defined using one or more tracking algorithms, which will be further discussed herein.

The axis to which each motor corresponds can depend on the mount platform 110 to which the gimbal 100 is attached. For example, when attached to the aerial vehicle 200, the first motor 301 can rotate the mounted object about the roll axis, the second motor 302 rotates corresponding to rotation in yaw and the third motor 303 corresponds to rotation in pitch. However, when the same gimbal 100 is attached to a handheld grip, the motors correspond to different axes: the first motor 301 corresponds to yaw, and the second motor 302 corresponds to roll, while the third motor 303 still corresponds to pitch.

In a conventional gimbal, each of the three motors 301, 302, 303 is associated with an orthogonal axis of rotation. However, in some embodiments, such as the embodiment depicted in FIG. 3A and FIG. 3B the motors 301, 302, 303 of the gimbal 100 are not orthogonal. A gimbal 100 in which the motors are not orthogonal will have at least one motor that rotates the mounted object about an axis which is not orthogonal to the axis of rotation of the other motors. In a gimbal 100 in which the motors are not orthogonal, operation of one motor of the gimbal 100 causes the angle of the camera 120 to shift on the axis of another motor. In the example embodiment shown in FIG. 3A and FIG. 3B, the first motor 301 and the third motor 303 have axes of rotation that are orthogonal to each other, and the second motor 302 and the third motor 303 are orthogonal, but the first motor 301 and second motor 302 are not orthogonal. Because of this configuration, when the gimbal 100 is coupled to the aerial vehicle 200 and the aerial vehicle 200 is level, operation of the first motor 301 adjusts only the roll of the camera 120 and the third motor 303 adjusts only the pitch of the camera 120. The second motor 302 adjusts the yaw primarily, but also adjusts the pitch and roll of the camera 120. Suppose for the purpose of example, the gimbal 100 is attached to the aerial vehicle 200 and the camera 120 is initially oriented at a pitch, yaw, and roll of 0° and that the axis of the second motor 302 is orthogonal to the axis of the third motor 303 and forms an angle of θ degrees with the vertical axis, as depicted in FIG. 3A and FIG. 3B. In FIG. 3B, the angle θ is measured clockwise, and is about 16°. A rotation of ϕ degrees (where −180°≤ϕ≤180°) by the second motor 302 will also change the pitch, p, of the camera 120 to p=(|ϕ|*θ)/90° where a pitch greater than 0 corresponds to the camera being oriented beneath the horizontal plane (i.e., facing down). The rotation of the second motor 302 by ϕ degrees will also change the roll, r, of the camera 120 to r=θ*(1−|ϕ−90°|/90°) in the case where −90°≤ϕ≤180° and the roll will change to r=−(θ*ϕ)/90°−θ in the case where −180°<ϕ<−90°. The change in the yaw, y, of the camera 120 will be equivalent to the change in angle of the second motor 102 (i.e., y=ϕ).

A non-orthogonal motor configuration of the gimbal 100 can allow for a larger range of unobstructed viewing angles for the camera 120. For example, in the embodiment shown in FIG. 3A and FIG. 3B, the pitch of the camera 120 relative to the connection of the gimbal 100 to the mount platform 110 (e.g., aerial vehicle 200) can be about 16° higher without the camera's frame being obstructed (i.e., without the motor appearing in the image captured by the camera) than it could with an orthogonal motor configuration. In some embodiments, the second motor 302 is not identical to the other two motors 301, 303. The second motor 302 can be capable of producing a higher torque than the other two motors 301, 303.

A larger value of θ (the angle between the second motor 302 and the axis orthogonal to the rotational axes of the other two motors) in a non-orthogonal motor configuration can provide a larger range of viewing angles for the mounted camera 120, but a larger θ will require the higher maximum torque than a comparable orthogonal motor configuration. Thus, embodiments in which the motors are not orthogonal should implement a value of θ in which the two design considerations of a large viewing angle for the camera 120 and the torque required from the motors are optimized. Consequently, the choice of θ will depend on many factors, such as the targeted price point of the gimbal 100, the type of cameras supported, the desired use cases of the gimbal, the available motor technology, among other things. It is noted that by way of example, θ can between 0°≤θ≤30°.

The gimbal 100 can support a plurality of different cameras with different mass distributions. Each camera can have a corresponding detachable camera frame (e.g., camera 120 corresponds to the camera frame 130), which secures the camera. A camera frame 130 may have a connector, or a multiplicity of connectors, which couple to the gimbal 100 and a connector, or a multiplicity of connectors, which couple to the camera 120. Thus, the camera frame 130 includes a bus for sending signals from the camera to the gimbal 100, which can, in some cases, be routed to the mount platform 110. In some embodiments, each detachable camera frame has the same types of connectors for coupling to the gimbal 100, but the type of connector that connects to the camera is specific to the type of camera. In another embodiment, the camera frame 130 provides no electronic connection between the camera 120 and the gimbal 100, and the camera 120 and the gimbal 100 are directly connected. In some embodiments, the gimbal 100 does not contain a bus and the camera 120 and the mount platform 110 communicate via a wireless connection (e.g., Bluetooth or Wi-Fi).

In some embodiments, the gimbal 100 has a mount connector 304 (shown in FIG. 3B, but not in FIG. 3A) which allows the gimbal 100 to electronically couple to the mount platform 110 (e.g., the aerial vehicle 200). The mount connector 304 can include a power connection which provides power to the gimbal 100 and the camera 120. The mount connector 304 can also allow communication between the sensor unit 101 and control logic unit 102 on the gimbal 100 and the control logic unit 113 on the mount platform 110. In some embodiments, the mount connector 304 connects to the camera 120 via busses (e.g., a camera control connection 140 and a camera output connection 141) which allow communication between the mount platform 110 and the camera 120.

The gimbal 100 also can couple mechanically to a mount platform 110 via a mechanical attachment portion 350. The mechanical attachment portion 350 can be part of the base arm 310. The mechanical attachment portion 350 can include a mechanical locking mechanism to securely attach a reciprocal component on a mount platform 110 (e.g., an aerial vehicle 200, a ground vehicle, an underwater vehicle, or a handheld grip). The example mechanical locking mechanism shown in FIGS. 3A and 3B includes a groove with a channel in which a key (e.g., a tapered pin or block) on a reciprocal component on a mount platform 110 can fit. The gimbal 100 can be locked with the mount platform 110 in a first position and unlocked in a second position, allowing for detachment of the gimbal 100 from the mount platform 110. The mechanical attachment portion 350 connects to a reciprocal component on a mount platform 110 in which the mechanical attachment portion 350 is configured as a female portion of a sleeve coupling, where the mount platform 110 is configured as a male portion of a sleeve coupling. The coupling between the mount platform 110 and the gimbal 100 can be held together by a frictional force. The coupling between the mount platform 110 and the gimbal 100 can also be held together by a clamping mechanism on the mount platform 110.

If the gimbal 100 supports multiple different cameras of differing mass distributions, the differences in mass and moments of inertia between cameras might cause the gimbal 100 to perform sub-optimally. A variety of techniques are suggested herein for allowing a single gimbal 100 to be used with cameras of different mass distributions. The camera frame 130 can hold the camera 120 in such a way that the camera frame 130 and camera 120 act as a single rigid body. In some embodiments, each camera which can be coupled to the gimbal 100 has a corresponding detachable frame, and each pair of camera and frame have masses and moments of inertia which are approximately the same. For example, if m_{ca} and m_{fa} are the masses of a first camera and its corresponding detachable frame, respectively, and if m_{cb} and m_{fb} are the masses of a second camera and its corresponding detachable frame, then, m_{ca}+m_{fa}≈m_{cb}+m_{fb}. Also, I_{ca} and I_{fa} are the matrices representing the moments of inertia for the axes around about which the first camera rotates for the first camera and the corresponding detachable frame, respectively. In addition, I_{cb} and I_{fb} are the corresponding matrices for the second camera and the corresponding detachable frame, respectively. Thereafter, I_{ca}+I_{fa}≈I_{cb}+I_{fb}, where “+” denotes the matrix addition operator.) Since the mounted object which is being rotated by the gimbal is the rigid body of the camera and detachable camera frame pair, the mass profile of the mounted object does not vary although the mass profile of the camera itself does. Thus, by employing detachable camera frames e.g., 130, with specific mass profiles a single gimbal 100 can couple to a multiplicity of cameras with different mass profiles.

In alternate embodiments, the mass profile of the camera 120 and camera frame 130 pair is different for each different type of camera, but control parameters used in the control algorithms, implemented by the gimbal control system 150, which control the motors, are changed to compensate for the different mass profiles of each pair camera and detachable camera frame. These control parameters can specify the acceleration of a motor, a maximum or minimum for the velocity of a motor, a torque exerted by a motor, a current draw of a motor, and a voltage of a motor. In one embodiment, the camera 120 and/or the camera frame 130 is communicatively coupled to either the gimbal 100 or the mount platform 110, and upon connection of a camera 120 to the gimbal 100 information is sent from the camera 120 to the gimbal control system 150 which initiates the update of control parameters used to control the motors of the gimbal 100. The information can be the control parameters used by the gimbal control system 150, information about the mass profile (e.g., mass or moment of inertia) of the camera 120 and/or camera frame 130, or an identifier for the camera 120 or the camera frame 130. If the information sent to the gimbal control system 150 is a mass profile, then the gimbal control system 150 can calculate control parameters from the mass profile. If the information is an identifier for the camera 120 or the camera frame 130, the gimbal control system 150 can access a non-volatile memory which stores sets of control parameters mapped to identifiers in order to obtain the correct set of control parameters for a given identifier.

In some embodiments, the gimbal 100 is capable of performing an auto-calibration sequence. This auto-calibration sequence may be performed in response to a new camera 120 being connected to the gimbal 100, in response to an unrecognized camera 120 being attached to the gimbal 100, in response to a new mount platform 110 being connected to the gimbal, or in response to an input from a user. Auto-calibration may involve moving the gimbal 100 to a number of set orientations. The speed at which the gimbal re-orients the camera 120 can be measured and compared to an expected speed. The torque exerted by the motor, the current draw of the motor, the voltage used to motor can be adjusted so that the movement of the gimbal 100 is desirable.

In some embodiments, the movement characteristics of the gimbal 100 are adjusted according the type of mount platform 110 that the gimbal 100 is connected to. For example, each type of mount platform 110 can specify the maximum rotation speed of the gimbal 100, the maximum torque applied by the motors 301, 302, 303, or the weight given to the proportional, integral, and derivative feedback components used in a PID controller used to control a motor 301, 302, or 303. In some embodiments, the motor power used for motion dampening is determined based on the type of connected mount platform 110.

### Handheld Grip

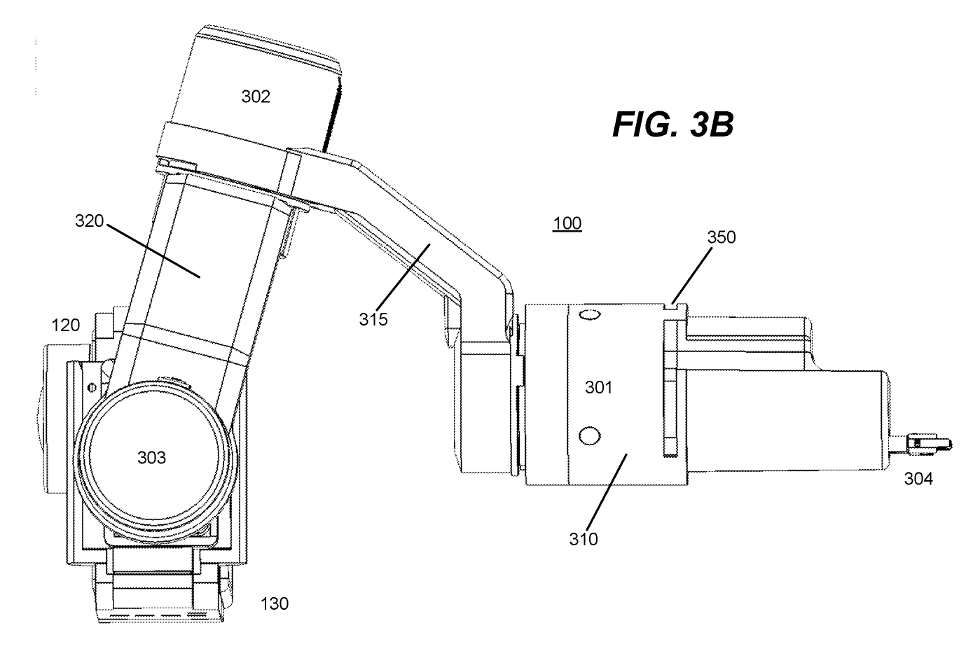

FIG. 4 illustrates an example embodiment of a mount platform 110 that can removably couple with the gimbal 100. In this example, the mount platform 110 is a handheld grip 400 that electronically and mechanically couples with the gimbal 100. The handheld grip 400 includes a plurality of buttons 405, 410, 415, 420, 425 which can be used by a user to control the camera 120 and/or the gimbal 100. The handheld grip 400 contains a battery from which it can provide power to the gimbal 100 and may also be used to power and/or charge the camera 120 in addition to operating any electronic functions on the handheld grip 400 itself.

The handheld grip 400 can be communicatively coupled to the camera 120 via a connection provided by the gimbal 100. The camera 120 can provide captured video content and images to the handheld grip 400. In one embodiment, the handheld grip can store the provided video content and images in storage media, such as a flash storage, which can be removably coupled to the handheld grip 400 (e.g., a secure digital memory card (SD card) or a micro SD card) or integrated into the handheld grip 400 itself. In an alternate embodiment, the handheld grip 400 has a port which can be sued to connect to another device, such as a personal computer. This port can allow the connected device to request and receive video content and images from the camera 120. Thus, the connected device, would receive content from the camera 120 via a connection running through the camera frame 130, the gimbal 100, and the handheld grip 400. In some embodiments, the port on the handheld grip 400 provides a USB connection. The handheld grip can also transmit executable instructions to the camera 120. These instructions can take the form of commands which are sent to the camera 120 responsive to a user pressing a button on the handheld grip 400.

In some embodiments, the handheld grip includes a plurality of buttons 405, 410, 415, 420, 425. An instruction can be sent from the handheld grip 400 to the camera 120 responsive to pressing a button. In one embodiment, a first button 405 takes a picture or a burst of pictures. The first button 405 can also begin recording a video or terminate the recording of a video if it is currently recording. In some embodiments, the camera 120 can be in a picture mode, in which it takes pictures or bursts of pictures, or a video mode, in which it records video. The result of pressing the first button 405 can be determined by whether the camera 120 is in video mode or camera mode. A second button 410 can toggle the mode of the camera 120 between the video mode and picture mode. A third button 415 can toggle the power of the camera 120. A forth button 420 can change the mode of the camera 120 so that it takes bursts of pictures rather than a single picture responsive to pressing the first button 405. A fifth button 425 can change the frame rate at which the camera 120 records videos. In some embodiments, a button on the handheld grip can also change the resolution or compression rate at which pictures or videos are recorded. The handheld grip can include light emitting diodes (LEDs) or other visual indicators which can indicate the mode that the camera is operating in. For example, an LED of a first color can be turned on in order to indicate that the camera 120 is in picture mode and an LED of a second color can be turned on to indicate that the camera 120 is in video mode. In some embodiments, the handheld grip 400 can include an audio output device, such as an electroacoustic transducer, which plays a sound responsive to pressing a button. The sound played by the audio output device can vary depending on the mode of the camera. By way of example, the sound that is played when a video recording is initiated is different than the sound that is played when a picture is taken. As will be known to one skilled in the art, additional buttons with additional functions can be added to the handheld grip 400 and some or all of the aforementioned buttons can be omitted. In one embodiment, the handheld grip 400 has only two buttons: a first button 405 which operates as a shutter button, and a second button 410 which instructs the camera 120 to include a metadata tag in a recorded video, where the metadata tag can specify the time at which the second button 410 was pressed.

In some embodiments, the rotational angle of the camera 120 to which each motor corresponds can vary depending on the mount platform 110 to which the gimbal 100 is attached. In the embodiment shown in FIG. 4, the first motor 301 controls the yaw of the camera 120, the second motor 302 (not shown in FIG. 4) controls the roll of the camera 120, and the third motor 303 controls the pitch of the camera 120. This configuration differs from that in FIG. 3A and FIG. 3B which depict the motors controlling the roll, yaw, and pitch, respectively. In some embodiments, the same gimbal 100 can operate in both configurations, responsive to the mount platform 110 to which it is connected. For example, when connected to the handheld grip 400 the gimbal's motors can operate as yaw, roll, and pitch motors, respectively, and when connected to the aerial vehicle 200 the gimbal's motors can operate as roll, yaw, and pitch motors.

In some embodiments, the camera's rotation for each axis of rotation can be fixed or unfixed. When the camera's rotation is fixed on an axis, then the camera will maintain that same orientation, relative to the ground, on that axis despite the movement of the handheld grip. Conversely, when the rotation of the camera 120 is unfixed on an axis, then the camera's rotation on that axis can change when the handheld grip 400 is rotated. For example, if the yaw of the camera 120 is unfixed then a change in the yaw of the handheld grip 400 by ϕ degrees can correspond to a change in the yaw of the camera 120 by ϕ or −ϕ degrees (depending on the point of reference for which the yaw is considered). If all three of the camera's axes are unfixed, then the motors 301, 302, 303 of the gimbal 100 will remain fixed (i.e., they will not turn) when the handheld grip 400 changes orientation. The gimbal control system 150 can have a fixed yaw mode and an unfixed yaw mode which dictates that the yaw of the camera 120 should remain fixed or unfixed, respectively. Similarly the gimbal control system 150 can have a fixed and unfixed mode for the roll and the pitch. The user can set the mode to unfixed for a certain axis and reorient the camera 120 to the desired angle along that axis, then set the mode for the axis to fixed so the camera 120 will remain at that angle. This will allow a user to easily set the preferred angle of the camera relative to the ground. The gimbal control system 150 can still stabilize the rotation along an axis, while in unfixed mode. In one embodiment, a second button 410 toggles the yaw mode between fixed and unfixed, the third button 415 toggles the pitch mode between fixed and unfixed, and the forth button 420 toggles the roll mode between fixed and unfixed. The axes of the gimbal 100 can be in a fixed mode or unfixed mode while connected to the aerial vehicle 200, as well. In one embodiment, the yaw is unfixed and the pitch and roll are fixed by default. In this embodiment, the yaw will be roughly fixed in the same direction relative to the mount device and the pitch and roll will remain fixed relative to a horizontal plane (e.g., the ground).

### Example Aerial Vehicle System

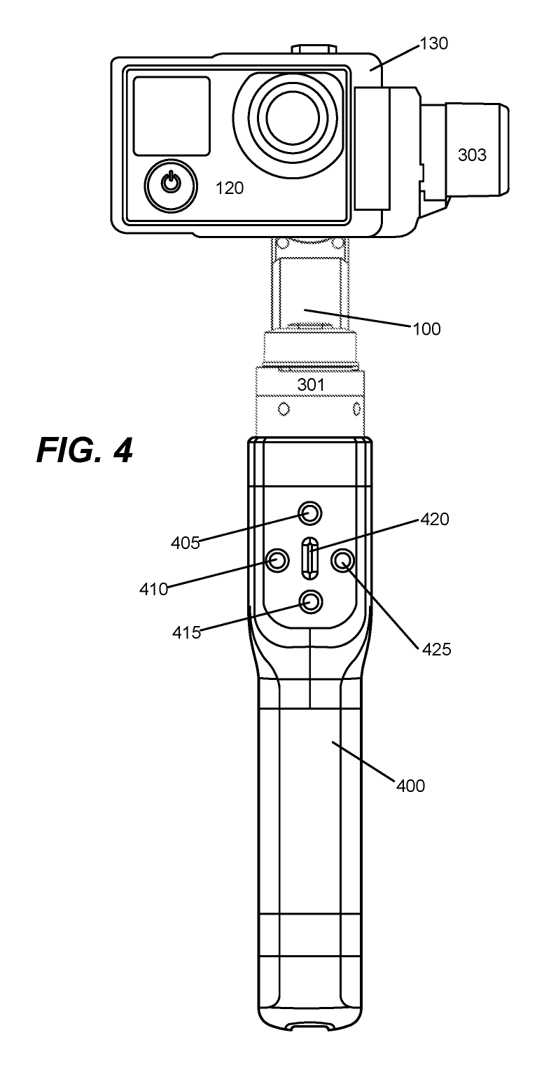

FIG. 5 illustrates a gimbal 100 attached to a remote controlled aerial vehicle 200, which communicates with a remote controller 520 via a wireless network 525. The remote controlled aerial vehicle 200 in this example is shown with a housing 230 and arms 235 of an arm assembly. In addition, this example embodiment shows a rotor 240 coupled with the end of each arm 235 of the arm assembly. Each rotor 240 is coupled to a propeller 510. The rotors 240 spin the propellers 510 when the motors are operational. The gimbal 100 connects a camera 120 to the remote controlled aerial vehicle 200.

The aerial vehicle 200 communicates with the remote controller 520 through the wireless network 525. The remote controller 520 may be a dedicated remote controller or can be another computing device such as a laptop, smartphone, or tablet that is configured to wirelessly communicate with and control the aerial vehicle 200. In one embodiment, the wireless network 525 can be a long range Wi-Fi system. It also can include or be another wireless communication system, for example, one based on long term evolution (LTE), 3G, 4G, or 5G mobile communication standards. In place of a single wireless network 525, the unidirectional RC channel can be used for communication of controls from the remote controller 520 to the aerial vehicle 200 and a separate unidirectional channel can be used for video downlink from the aerial vehicle 200 to the remote controller 520 (or to a video receiver where direct video connection may be desired).

The remote controller 520 in this example includes a first control panel 550 and a second control panel 555, an ignition button 560, a return button 565, and a screen 570. A first control panel, e.g., 550, can be used to control “up-down” direction (e.g. lift and landing) of the aerial vehicle 200. A second control panel, e.g., 555, can be used to control “forward-reverse” direction of the aerial vehicle 200. Each control panel 550, 555 can be structurally configured as a joystick controller and/or touch pad controller. The ignition button 560 can be used to start the rotary assembly (e.g., start the propellers 510). The return button 565 can be used to override the controls of the remote controller 520 and transmit instructions to the aerial vehicle 200 to return to a predefined location as further described herein. The ignition button 560 and the return button 565 can be mechanical and/or solid state press sensitive buttons. In addition, each button may be illuminated with one or more light emitting diodes (LED) to provide additional details. For example the LED can switch from one visual state to another to indicate with respect to the ignition button 560 whether the aerial vehicle 200 is ready to fly (e.g., lit green) or not (e.g., lit red) or whether the aerial vehicle 200 is now in an override mode on return path (e.g., lit yellow) or not (e.g., lit red). It also is noted that the remote controller 520 can include other dedicated hardware buttons and switches and those buttons and switches may be solid state buttons and switches. The remote controller 520 can also include hardware buttons or other controls that control the gimbal 100. The remote control can allow it's user to change the preferred orientation of the camera 120. In some embodiments, the preferred orientation of the camera 120 can be set relative to the angle of the aerial vehicle 200. In another embodiment, the preferred orientation of the camera 120 can be set relative to the ground.

The remote controller 520 also includes a screen (or display) 570 which provides for visual display. The screen 570 can be a touch sensitive screen. The screen 570 also can be, for example, a liquid crystal display (LCD), an LED display, an organic LED (OLED) display or a plasma screen. The screen 570 allow for display of information related to the remote controller 520, such as menus for configuring the remote controller 520 or remotely configuring the aerial vehicle 200. The screen 570 also can display images or video captured from the camera 120 coupled with the aerial vehicle 200, wherein the images and video are transmitted via the wireless network 525. The video content displayed by on the screen 570 can be a live feed of the video or a portion of the video captured by the camera 120. I.e., the video content displayed on the screen 570 is presented within a short time (preferably fractions of a second) of being captured by the camera 120. In some embodiments, the layout of the visual display is adjusted based on the camera 120 connected to the gimbal 100. For example, if the camera 120 is not capable of providing a live feed of captured video, the visual display layout may be adjusted to omit a panel for display of the live camera feed, whereas otherwise the life feed would be displayed.

The video may be overlaid and/or augmented with other data from the aerial vehicle 200 such as the telemetric data from a telemetric subsystem of the aerial vehicle 200. The telemetric subsystem includes navigational components, such as a gyroscope, an accelerometer, a compass, a global positioning system (GPS) and/or a barometric sensor. In one example embodiment, the aerial vehicle 200 can incorporate the telemetric data with video that is transmitted back to the remote controller 520 in real time. The received telemetric data is extracted from the video data stream and incorporate into predefine templates for display with the video on the screen 570 of the remote controller 520. The telemetric data also may be transmitted separate from the video from the aerial vehicle 200 to the remote controller 520. Synchronization methods such as time and/or location information can be used to synchronize the telemetric data with the video at the remote controller 520. This example configuration allows a user, e.g., operator, of the remote controller 520 to see where the aerial vehicle 200 is flying along with corresponding telemetric data associated with the aerial vehicle 200 at that point in the flight. Further, if the user is not interested in telemetric data being displayed real-time, the data can still be received and later applied for playback with the templates applied to the video.

The predefine templates can correspond with “gauges” that provide a visual representation of speed, altitude, and charts, e.g., as a speedometer, altitude chart, and a terrain map. The populated templates, which may appear as gauges on the screen 570 of the remote controller 520, can further be shared, e.g., via social media, and or saved for later retrieval and use. For example, a user may share a gauge with another user by selecting a gauge (or a set of gauges) for export. Export can be initiated by clicking the appropriate export button, or a drag and drop of the gauge(s). A file with a predefined extension will be created at the desired location. The gauge to be selected and be structured with a runtime version of the gauge or can play the gauge back through software that can read the file extension.

### Rotating Platform

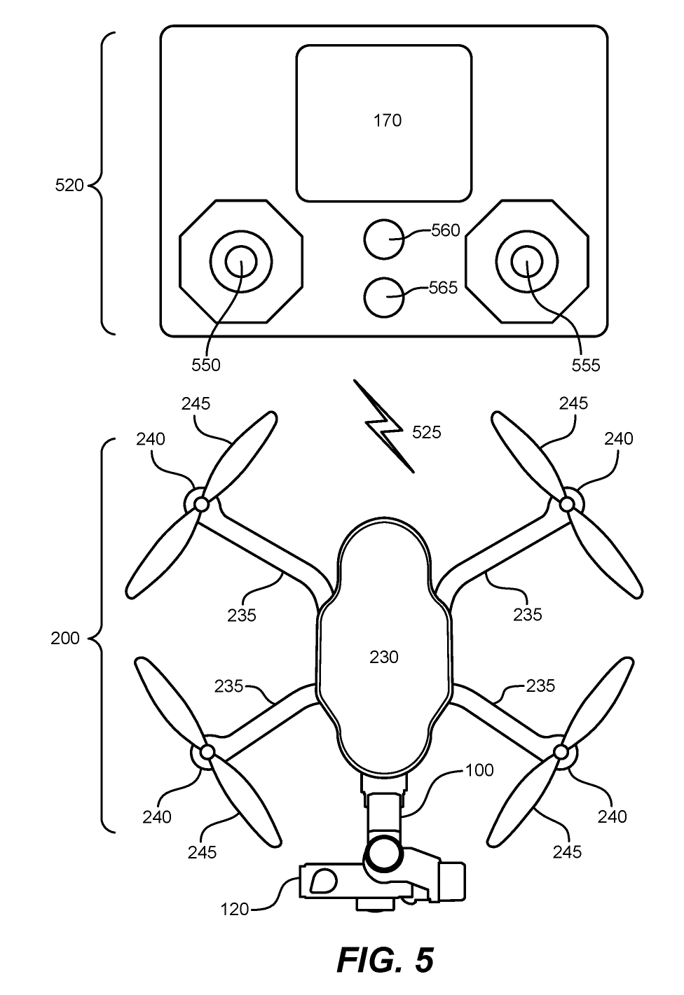

FIG. 6 illustrates an example embodiment of a gimbal 100 coupled to a rotating platform 600. The rotating platform 600 comprises a base 610 and a rotating gimbal mount 620. The mount connector 304 of the gimbal 100 couples to a reciprocal coupling end of the rotating gimbal mount 620. The base 610 may contain a motor which rotates a shaft, which is coupled to the rotating gimbal mount 620. Operation of this motor can be controlled by control logic in the rotating platform 600. The motor in the base 610 can be used to rotate the gimbal 100 and the camera 120, thus facilitating panning of the camera 120 or tracking of an object. The camera 120 in FIG. 6 is depicted with a pitch of about 45° upwards.

The rotating gimbal mount 620 rotates relative to the base 610, which in turn rotates the gimbal 100 and the camera 120. In this configuration, when the base 610 is level relative to the ground, rotation of the rotating gimbal mount 620 adjusts the yaw of the camera 120. If the first motor 301 of the gimbal 100 is not able to rotate continuously (e.g., the first motor 301 is restricted to a certain range of angles) the rotating platform 600 can be used to continuously rotate the camera 120, whereas otherwise that would not be possible.

In some embodiments, the motor which rotates the rotating gimbal mount 620 and the first motor 301 of the gimbal 100 have the same axis of rotation. The gimbal control system 150 can utilize both the first motor 301 and the motor connected to the rotating gimbal mount 620 in conjunction. The motor connected to rotating gimbal mount 620 can be capable of relatively high torque and speed, but be less precise than the first motor 301. The motor connected to rotating gimbal mount 620 can be used to provide large rotational velocity and acceleration, while the first motor 301 performs comparatively smaller rotations that serve to smooth out the panning of the camera 120.

The base 610 may also contain a battery, with which it provides power to the gimbal 100 and the camera 120. The base 610 may also connect to an external power supply. In some embodiments, the base includes an interface to receive instructions to perform an action with the camera 120 or instructions that specify which object the camera 120 is to track. The interface may be a physical interface such as buttons, switches, or a touch screen by which input from a user is received. The interface can be a communication interface which allows the rotating platform 600 to receive instructions from an external device. This external device can, for example, be a dedicated remote controller or a generic user device. The communication interface can be a wired communication interface which utilizes protocols such as Ethernet, USB, or HDMI or a wireless communication interface such as a WiFi or Bluetooth. The communication interface can be used to receive instructions and to transmit images and video captured by the camera 120 to the external device. In some embodiments, the base 610 also includes weights, which serve to keep the rotating platform 600 upright and stable. In some embodiments, the base 610 can be directly connected to a floor or wall.

The base 610 of the rotating platform 600 may include a control logic unit 113. The control logic unit 113 may implement an algorithm in which the rotating gimbal mount 620 is used for panning rotation and the motors 301, 302, 303 of the gimbal 100 are used for precise movement. For example, if the camera 120 is tracking a quick-moving object, then, in order to track the object, the yaw of the camera 120 may need to be rotated quickly. The control algorithm implemented by the control logic unit 113 can do “broad” tracking, in regards to yaw, with the rotating gimbal mount 620 and “precise” tracking with the first motor 301 of the gimbal 100. In this manner, a powerful, imprecise motor in the rotating platform 600 and an accurate, low torque first motor 301 in the gimbal 100 may be used in conjunction to produce a yaw rotation that is quick, which a potential for high acceleration, but is still able to track an object precisely.

In some embodiments, the control logic unit 113 of the rotating platform 600 controls the camera 120, the motor in the base 610, and/or the gimbal 100 to pan the camera 120 to take panoramic photos. Capturing a panoramic photo may comprise capturing multiple images with the camera 120 at different orientations and stitching the images together with image processing software to generate a single composite panoramic photo. In some embodiments, the panoramic photo comprises a 360° photo. In some embodiments, the control logic unit 113 controls the camera 120, the motor in the base 610, and/or the gimbal 100 to pan the camera slowly in order to generate a time lapse video. The frame rate of the time lapse video may be based on the movement speed of an object tracked by the camera 120. The frame rate may be determined such that the tracked object appears to move smoothly in the video. For example, a time lapse video can be captured of a hiker who is far away from the camera 120. The control logic unit 113 can control the panning and image capture of the camera 120 to capture time lapse video in which the hiker moves smoothly without capturing an excessive number of frames. The time lapse may be captured with or without panning the camera 120.

### Pole Mount Apparatus

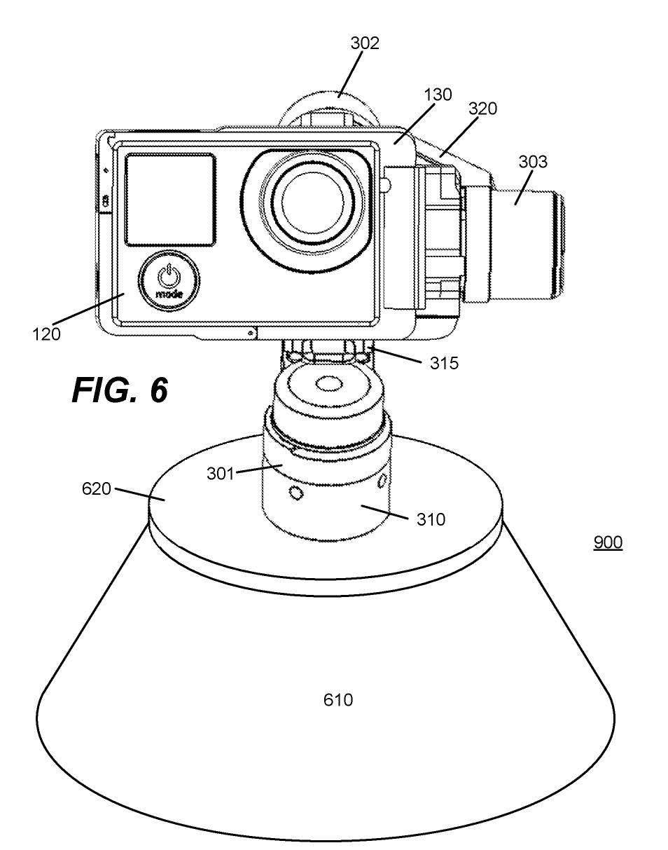

FIG. 7 illustrates an example embodiment of a gimbal 100 coupled to a pole mount apparatus 700. The pole mount apparatus 700 consists of an upper clamp 710, a lower clamp 720, a controller 730, and a cable 740. The two clamps 710, 720 are removably coupled to a pole 750. The cable 740 connects the upper and lower clamps 710, 720. The upper clamp 710 comprises a connection housing 711, an outer shell 712, and an inner shell 713. The gimbal 100 can be removably coupled to the upper clamp 710. The mount connector 304 of the gimbal 100 couples to a reciprocal coupling end in the connection housing 711. The lower clamp 720 can be coupled to the controller 730.

In some embodiments, the upper clamp 710 is equipped with at least one electric motor, which rotates the connection housing 711 and the outer shell 712 about the axis of the pole 750. The inner shell 713 remains rigidly coupled to the pole while the outer shell 712 rotates. In this configuration, the gimbal 100 can continuously rotate about the pole 750 without twisting the cable 740 connecting the upper clamp 710 to the lower clamp 720, which is coupled to the inner shell 713. In alternate embodiments, the upper clamp 710 consists of a single shell and when locked to the pole 750 cannot rotate.

In some embodiments, the clamps 710, 720 are not removable from the pole 750. As such embodiments, the two clamps 710, 720 can be locked onto the pole 750, which prevents them from being moved. The clamps 710, 720 can be unlocked which allows them to slide up and down the pole 750, but not detached from the pole 750. In some embodiments, the clamps 710, 720 can also be rotated around the pole 750 when unlocked. In some embodiments, the lower clamp 720 is rigidly coupled to the pole 750 and cannot be unlocked, shifted vertically, or rotated without the use of tools. In alternate embodiments, the lower clamp 720 is omitted entirely and the controller 730 is connected directly to the pole 750. In some embodiments, the upper clamp 710 is omitted and the mount connector 304 of the gimbal 100 couples directly to a corresponding connector on the pole 750. In some embodiments, the height of the pole 750 is adjustable.

In some embodiments, at least one of the clamps 710, 720 has a first locking mechanism which enables the clamp to move up and down the pole 750 or to detach from the pole 750 entirely and a second locking mechanism which enables the clamp to be rotated about the pole 750. The upper clamp 710 can have a locking mechanism which when locked or unlocked, serves to fix the rotation of the outer shell 712 or allow for rotation of the outer shell 712, respectively. In some embodiments, the lower clamp 720 is always free to rotate. In some embodiments, the clamps 710, 720 are capable of coupling to poles having a range of thicknesses.

The controller 730 allows for user input to the control the operation of the camera 120, the gimbal 100, or the rotation of the outer shell 712. The controller 730 may include a display that provides for display of video or images captured by the camera 120. The controller 730 can receive an input from a user through buttons, switches, or a touch screen and transmit an instruction to the camera 120 to perform an action. This can be an instruction to take a picture or a burst of pictures, begin recording a video, terminate the recording of a video, toggle the mode of the camera 120 between a video mode and a picture mode, toggle the power of the camera 120, change the mode of the camera 120 so that it takes bursts of pictures rather than a single picture, change the frame rate at which the camera 120 records videos, change the resolution or compression rate at which pictures or videos are recorded. The controller 730 can also receive input from a user to trigger the gimbal 100 or upper clamp 710 to perform an action. For example, after receiving an input from a user, the controller 730 can transmit a command to the gimbal 100 to change the orientation of the camera 120, or transmit a command to the upper clamp 710 to rotate. In some embodiments the controller 730 receives power from an internal battery or an external power source and provides power through the cable 740 to the gimbal 100, the motor of the upper clamp 710, or the camera 120. In some embodiments, the controller 730 contains a control logic unit 113 which is part of the gimbal control system 150 which controls the movement of the gimbal 100. The control logic unit 113 may implement a tracking method, such as control methods 1000, 1020, 1030, 1040. It is noted that control methods 1000, 1020, 1030, 1040 may be implemented using a combination of the second and third motors 302, 303 of the gimbal 100 and an electric motor in the upper clamp 710 to track the horizontal movement of a tracked object.

Unlike the handheld grip 400 or aerial vehicle 200, the pole mount apparatus 700 is not expected to move. Consequently, the gimbal control system 150 can leave the roll of the camera 120 fixed, rather than continuously parsing data from the sensor unit 101 of the gimbal 100 in order to detect changes. If the gimbal 100 is not actively tracking an object, then it may be advantageous to fix all of the motors 301, 302, 303 of the gimbal 100. Alternately, the gimbal control system 150 can operate using reduced complexity or with a lower frequency of receiving input from the sensing unit 101. These simplifications can result in reduced computational complexity and power consumption for the gimbal control system 150.

In some embodiments, the cable 740 provides a wired connection which allows for communication between the controller 730 and the gimbal 100 or the camera 120. The cable 740 can transmit commands input by a user into the controller 730 to the gimbal 100, the camera 120, or the upper clamp 710. The controller 730 may also receive captured images or video from the camera 120 through the cable 740. A control logic unit 102 and sensor unit 101 on the gimbal 100 can communicate through the cable 740 with control logic unit 13 on the controller 730 in order to provide for control of the gimbal 100. In some embodiments, the cable is internal to the pole 750. In yet other embodiments, the cable 740 could be replaced with a wireless communication connection, e.g., Bluetooth.

In some embodiments, the cable 740 retracts into the upper clamp 710 or lower clamp 720. For example, a button on the lower clamp 720 can cause the cable 740 to be automatically retracted into the lower clamp. In this manner a user can easily mitigate excess cable slack.

In some embodiments, the cable 740 is omitted and the controller communicates wirelessly with the gimbal 100 or the camera 120. In some embodiments, the controller 730 is not attached to the rest of the pole mount apparatus 700, and function as a wireless remote controller. In some embodiments, the controller 730 includes a network interface which allows for communication with a network such as a Wi-Fi network. The controller 730 may receive commands or transmit images and video over the network to a second device.

### Gimbal Control System

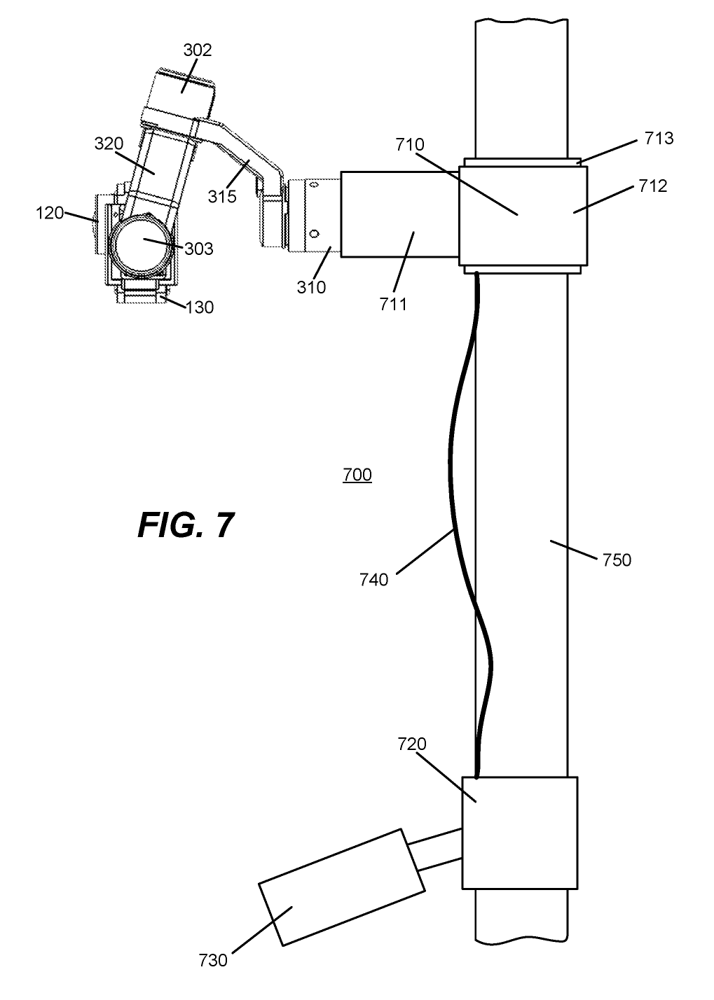

FIG. 8 illustrates the gimbal control system 150, in accordance with an example embodiment. The gimbal control system 150 may include the IMU 103 of the gimbal 100, an orientation controller 810, a rate controller 820, a current controller 830, a soft stop module 840, a flip module 850, and a combiner 812. The gimbal control system 150 may control one or more motors 860 of the gimbal 100 (e.g., motors 301, 302, and/or 303) according to a soft stop control technique based on an orientation control signal 880 representing a target orientation of the gimbal 100. For illustrative purposes, FIG. 8 illustrates a single motor 860, but the gimbal control system 150 may control multiple motors in a similar manner. The gimbal control system 150 may include respective rate controllers 820 and respective current controllers 830 for each motor 860.

The motor 860 controls rotation of a gimbal arm about one of the gimbal axes as described above. Each motor 860 may be limited in its rotational range of motion about its respective axis. For example, a motor 860 may be limited to rotation between a minimum angle −X° and a maximum angle +X°. The limit of rotation may be based on a mechanical stopping mechanism that prevents the motor 860 from rotating beyond these limits irrespective of the control input. When rotation of the motor 860 is stopped by a mechanical stop, it may produce vibration in the camera 120, reducing the visual quality of video or images being captured by the camera 120. In some cases, the motor 860 may be damaged when rotation is stopped suddenly by a mechanical stop. Thus, the gimbal control system 150 operates according to a soft stop control technique that ensures that the motors 860 are gradually stopped as they approach their physical limits to avoid these undesired consequences.

Each motor 860 includes a rotary encoder 870 that senses the angular position of the motor 860 and outputs a sensed motor angle 808 indicative of the angular position. In alternative embodiments, the rotary encoder 870 may instead sense an angular rate of rotation of the motor 860 and output a rotation rate instead of the sensed motor angle 808.

The orientation controller 810 processes sensor and control inputs (e.g., sensed camera orientation 806, flip signal 804, orientation control signal 880, and motor angle 808) to determine an initial target motor rate 802 (e.g., a target angular velocity) for controlling the motor 860. The orientation control signal 880 represents a target orientation for the camera 120 attached to the gimbal 100. The orientation control signal 880 may represent an absolute orientation (e.g., an angle) or may represent a direction in which to move the camera 120. The orientation control signal 880 may be generated, for example, by the controller 520 from a user input or may be generated automatically based on an automated control algorithm (e.g., an object tracking algorithm that causes the orientation of the camera 120 to track an object). The orientation controller 810 also receives the sensed camera orientation 806 from the IMU 103 of the gimbal 100 representing a sensed orientation of the camera 120 and the sensed motor angle 808 of the motor 860. The orientation furthermore receives a flip signal 804 discussed below. The orientation controller 810 determines the initial target motor rate 802 that will cause the motor 860 to adjust its position to follow the orientation control signal. For example, the initial target motor rate 802 may cause the camera 120 to move in a direction towards matching the orientation control signal 880 within certain motion constraints. The initial target motor rate 802 may be constrained by minimum or maximum motor speeds or may be constrained based on motor angle limits as discussed below. In some embodiments, the initial target motor rate 802 may be based on a direction and angular distance between the sensed camera orientation 806 and the orientation control signal 880. For example, if a large angle change is desired to orient the camera 120 in the targeted way, the initial target motor rate 802 may specify a higher magnitude rate than if only a very small angle change is desired. The flip signal 804 may be a binary signal that when asserted, causes the orientation control signal 880 to be rotated 180 degrees or some other fixed amount. For example, if the orientation control signal 880 indicates a roll of 0°, the flip signal 804 may cause the orientation control signal 880 to instead indicate a roll of 180°, thus causing the camera 120 to flip over. As explained in further detail below, this signal may be asserted when it is detected that due to limited angle ranges of the motors 860, the camera 120 can be more closely oriented to the desired orientation by flipping the camera 120 and adjusting the other motors 860 accordingly.

A combiner 812 combines the initial target motor rate 816 (e.g., additively combines) with a motor rate adjustment 814 (discussed below) to produce an adjusted target motor rate 816, which is received by the rate controller 820. Alternatively, the combiner 812 may subtract the motor rate adjustment 814 from the initial target motor rate 802, or generate a product.

The rate controller 820 receives the adjusted target motor rate 816 and the sensed motor angle 808 from the rotary encoder 870 of the motor 860 and generates a current control signal 818 that controls the power delivered to the motor 860. For example, the rate controller 820 determines a rate of rotation of the motor 860 based on a change in the sensed motor angle 808 (e.g., by subtracting the sensed motor angle 808 of the motor 860 from a previously sensed motor angle). In alternate embodiments in which the motor 860 includes an incremental rotary encoder 870, the rate controller 820 receives the rate of rotation directly from the incremental rotary encoder 870 in addition to or instead of receiving the motor angle 816 from the rotary encoder 870.

The rate controller 820 may use a control loop such as a PID controller or a proportional-summation-difference (PSD) controller to generate a current control signal 818 based on the sensed rate of rotation of the motor 860 and the target adjusted motor rate 816. For example, the rate controller 820 may use the target adjusted motor rate 816 as the setpoint of the control loop and may use the difference between the sensed rate of rotation and the target adjusted motor rate 816 as negative feedback to determine the current control signal 818.

The current controller 830 receives the current control signal 818 and generates a power current 822 to drive the motor 860 in accordance with the received current control signal 818. The power current 860 may be a direct current or an alternating current (e.g., a multi-phase current).

The soft stop module 840 determines the motor rate adjustment 814 based on the sensed motor angle 808 received from the rotary encoder 870 of the motor 860. The soft stop module 840 generates the motor rate adjustment 814 in a manner that causes the motor 860 to come to a gradual stop as it approaches its mechanical limit as will be described in further detail below. For example, when the sensed motor angle 808 is far from the mechanical angle limits (within a “nominal region”), the motor rate adjustment 814 may be zero or near zero. However, when the sensed motor angle 808 is approaching the mechanical limit (within a “soft stop region”), the soft stop module 840 increases the motor rate adjustment 814 to gradually slow the motor 860 as it approaches the mechanical limit and eventually stop the motor 860 at or just before it reaches the mechanical limit. In one embodiment, the soft stop module 840 may produce a motor rate adjustment 814 when the orientation is within a soft stop region that moves the camera outside of the soft stop region back into the nominal region.

The soft stop module 840 may also generate a soft stop signal 824 provided to the flip module 850. The soft stop signal 824 may indicate whether the angle of the motor 860 is currently in a soft stop region.

The flip module 850 receives the soft stop signal 824 indicating whether or not the angle of the motor 860 is in a soft stop region. Based on the duration that the angle of the motor 860 is in a soft stop region, the flip module 850 may determine whether to flip to another orientation. Flipping to another orientation may include determining that the camera 120 can be directed towards a target direction and be level at another orientation, different than the current orientation. For example, if the camera 120 is currently has a roll of 0° with respect to the horizon but the first motor 301 of the gimbal 100 is in the soft stop region, the flip module 850 may analyze the control space for alternate orientations. The flip module 850 may determine that if the camera 120 is oriented with a roll of 180° (i.e., inverted) with respect to the ground, all the motors (e.g., motors 301, 302, 303) will be in their respective nominal regions. The flip module 850 may send a flip signal to the orientation controller 810 indicating that the camera 120 should be rotated into this alternate orientation. In response, the orientation controller 810 may perform a rotation or a sequence of rotations to re-orient the camera 120 into this alternate orientation. In this manner, level video can still be recorded by the camera 120, and the video can be later flipped in post processing to recover upright, level video. In alternate embodiments, the flip module 850 may determine to flip based on other factors.

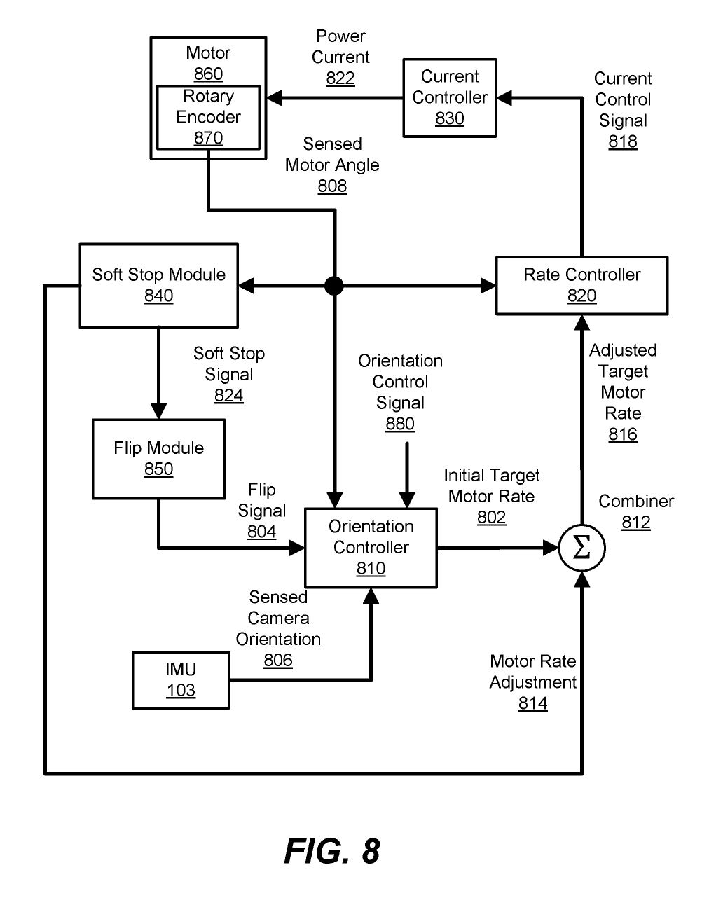

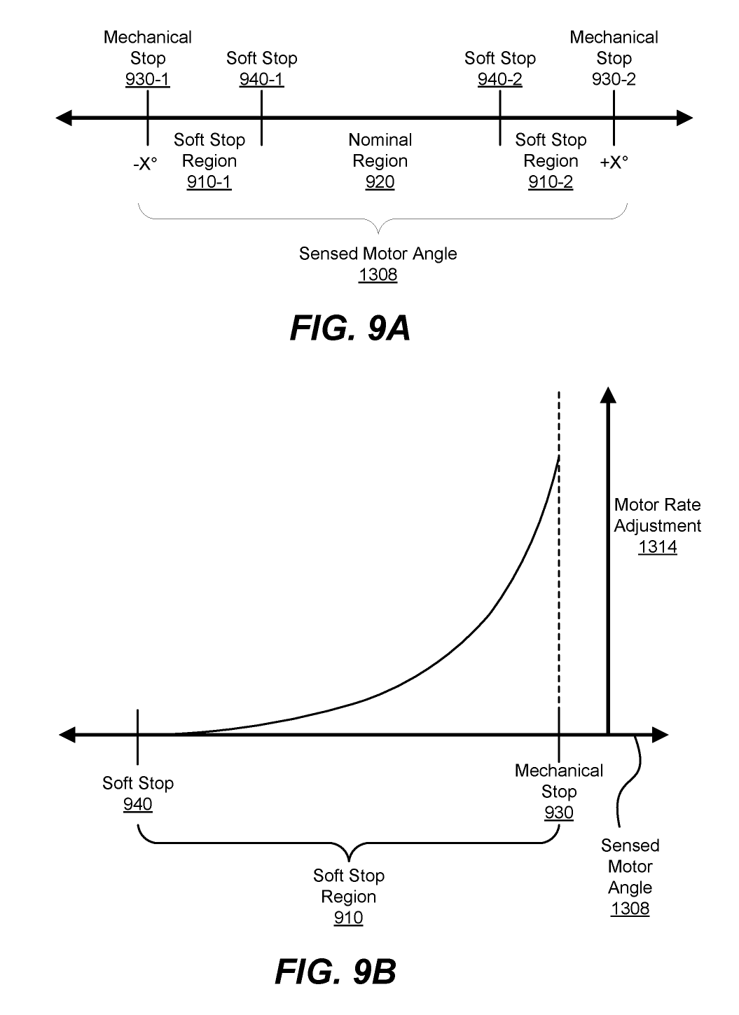

FIG. 9A illustrates control regions for controlling a gimbal 100 according to a soft stop control scheme. Each motor of the gimbal 100 can be controlled over a range of angles 900 from a minimum angle −X° and a maximum angle +X°. The minimum and maximum angles −X°, +X° are defined by respective mechanical stops 930 (e.g., a first mechanical stop 930-1 and a second mechanical stop 930-2) that represent the mechanical limits of the rotation angle of the motor.

The nominal region 920 represents a range of rotation angles in which the motor is nominally controlled. In the nominal region 920, the motor freely rotates the motor to a target angle indicated by the initial target motor rate 802 with little or no motor rate adjustment 814. The soft stop regions 1410 (e.g., a first soft stop region 910-1 and a second soft stop region 910-2) includes the regions between the respective mechanical stops 930 and the nominal region 920. Soft stop boundaries 940 (e.g., a first soft stop boundary 940-1 and a second soft stop boundary 940-2) comprise respective angles at the respective boundaries between the nominal region 920 and the respective soft stop regions 930. In the soft stop regions 910, a motor rate adjustment 814 is generated to slow the motor 860 as it approaches the mechanical stop 930, and in some cases, to cause the sensed motor angle 808 to move back into the nominal region 920.

FIG. 9B illustrates an example control scheme for controlling the motor rate adjustment 814 within a soft stop region 940. Here, the soft stop module 840 may determine the motor rate adjustment 814 according to a function of the motor angle 808. Particularly, the motor rate adjustment 814 may be small or zero when the motor angle 900 is within the nominal region 920. Within the soft stop region 910, the motor rate adjustment 814 may increase as the angle of the motor 860 approaches the mechanical stop 930. The sign (i.e., negative or positive) of the motor rate adjustment 814 may be set such that the motor adjustment rate 814 causes the motor 860 to gradually slow as it reaches the mechanical stop 930. In one embodiment, the motor rate adjustment 814 is only applied (e.g., non-zero) when the motor initial target motor rate 802 would otherwise cause the motor 860 to move in a direction towards the mechanical stop 930 when in the soft stop region 910. If the motor 860 is in a soft stop region 910 but the initial target motor rate 802 controls the motor 860 to move away from the mechanical stop 930 or controls the motor to be stationary, then the motor rate adjustment 814 may be set to zero or near zero. In an alternative embodiment, the soft stop module 840 automatically causes the motor angle 808 to move outside of the soft stop region 910. Thus, for example, if the initial target motor rate 802 controls the motor to be stationary or near stationary within the soft stop region, the motor rate adjustment 814 may cause the motor 860 to move out of the soft stop region 910. In some embodiments, the motor rate adjustment determined by the soft stop module 840 increases exponentially in the soft stop region 930 as the motor angle 808 approaches the mechanical stop 930.

In alternative embodiments, soft stops 940 may be implemented to constrain motion of the motors 860 based on other limits that are not necessarily physical limits. For example, in one embodiment, the mechanical stop may be set to constrain the orientation of the camera 120 so that the field of view remains unobstructed. For example, when the mount platform 110 that the gimbal 100 is connected to is an aerial vehicle 200, soft stops 940 may be configured to prevent the motors 860 from reaching angles in which the field of view would be obstructed by the propellers 245, rotors 240, and/or arms 235.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for the disclosed embodiments. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A gimbal comprising:
a gimbal arm;
a motor configured to rotate the gimbal arm about a rotational axis, the motor mechanically constrained to rotate within a limited angle range;
a rotary encoder to detect a sensed motor angle of the motor; and
a gimbal controller to control the motor to rotate the gimbal arm based on a target orientation and the sensed motor angle, the gimbal controller to detect when the motor angle is within a soft stop region between a mechanical stop corresponding to a boundary of the limited angle range and a soft stop boundary at a predefined offset angle from the mechanical stop, and the gimbal controller to control the motor to slow its rate of rotation when in the soft stop region and when the target orientation is in a direction of the mechanical stop relative to the sensed motor angle such that the motor is gradually stopped as it approaches the mechanical stop.

2. The gimbal of claim 1, wherein the gimbal controller further controls the motor to follow the target orientation when the sensed angular position is within a nominal angle range in between soft stop boundaries.

3. The gimbal of claim 1, wherein the gimbal controller comprises:
an orientation controller to receive the target orientation, the sensed motor angle, and a sensed camera orientation of a camera attached to the gimbal arm, the orientation controller to generate an initial target motor rate for causing the motor to move to the camera from the sensed camera orientation to the target orientation based on the sensed motor angle;
a combiner to combine the initial target motor rate with a motor rate adjustment signal to generate an adjusted target motor rate; and
a soft stop module to generate the motor rate adjustment based on the sensed motor angle.

4. The gimbal of claim 3, wherein the gimbal controller further comprises:
a rate controller to generate a current control signal based on the adjusted target motor rate; and
a current controller to generate a power current for driving the motor based on the current control signal.

5. The gimbal of claim 3, wherein the soft stop module furthermore generates a soft stop signal indicating whether the sensed motor angle is within the soft stop region, wherein the gimbal controller further comprises:
a flip module to receive the soft stop signal and to detect when the sensed motor angle remains within the soft stop region for a predefined time length, the flip module to assert a flip signal in response to the sensed motor angle remaining in the soft stop region for the predefined time length, the flip signal when asserted causing the orientation controller to rotate the target orientation by a predefined angle.

6. The gimbal of claim 3, wherein the soft stop module generates the motor rate adjustment to vary exponentially with respect to the sensed motor angle as the sensed motor angle approaches the mechanical stop.

7. The gimbal of claim 1, wherein the mechanical stop comprises a physical limit of the motor.

8. An aerial vehicle platform comprising:
an aerial vehicle;
a gimbal coupled to the aerial vehicle, the gimbal comprising a plurality of motors to rotate respective gimbal arms around different rotational axes, each of the motors mechanically constrained to rotate within respective limited angle ranges, and each of the motors including a rotary encoder to detect respective sensed motor angles of the respective motors; and
a gimbal controller to control a motor of the plurality of motors to rotate a corresponding gimbal arm based on a target orientation and a sensed motor angle for the motor, the gimbal controller to detect when the sensed motor angle is within a soft stop region between a mechanical stop corresponding to a boundary of the limited angle range and a soft stop boundary at a predefined offset angle from the mechanical stop, and the gimbal controller to control the motor to slow its rate of rotation when in the soft stop region and when the target orientation is in a direction of the mechanical stop relative to the sensed motor angle such that the motor is gradually stopped as it approaches the mechanical stop; and
a camera mounted to the gimbal.

9. The aerial vehicle platform of claim 8, wherein the gimbal controller further controls the motor to follow the target orientation when the sensed angular position is within a nominal angle range in between soft stop boundaries.

10. The aerial vehicle platform of claim 8, wherein the gimbal controller comprises:
an orientation controller to receive the target orientation, the sensed motor angle, and a sensed camera orientation of the camera attached to the gimbal arm, the orientation controller to generate an initial target motor rate for causing the motor to move to the camera from the sensed camera orientation to the target orientation based on the sensed motor angle;
a combiner to combine the initial target motor rate with a motor rate adjustment signal to generate an adjusted target motor rate; and
a soft stop module to generate the motor rate adjustment based on the sensed motor angle.

11. The aerial vehicle platform of claim 10, wherein the gimbal controller further comprises:
a rate controller to generate a current control signal based on the adjusted target motor rate; and
a current controller to generate a power current for driving the motor based on the current control signal.

12. The aerial vehicle platform of claim 10, wherein the soft stop module furthermore generates a soft stop signal indicating whether the sensed motor angle is within the soft stop region, wherein the gimbal controller further comprises:
a flip module to receive the soft stop signal and to detect when the sensed motor angle remains within the soft stop region for a predefined time length, the flip module to assert a flip signal in response to the sensed motor angle remaining in the soft stop region for the predefined time length, the flip signal when asserted causing the orientation controller to rotate the target orientation by a predefined angle.

13. The aerial vehicle platform of claim 10, wherein the soft stop module generates the motor rate adjustment to vary exponentially with respect to the sensed motor angle as the sensed motor angle approaches the mechanical stop.

14. The aerial vehicle platform of claim 8, wherein the mechanical stop comprises a physical limit of the motor.

15. A method for controlling a gimbal having a gimbal arm and a motor configured to rotate the gimbal arm about a rotational axis, the motor mechanically constrained to rotate within a limited angle range, the method comprising:
detecting, by a rotor encoder, a sensed motor angle of the motor;
detecting when the sensed motor angle is within a soft stop region between a mechanical stop corresponding to a boundary of the limited angle range and a soft stop boundary at a predefined offset angle from the mechanical stop; and
controlling, by a gimbal controller, the motor to slow its rate of rotation when the sensed motor angle is in the soft stop region and when the target orientation is in a direction of the mechanical stop relative to the sensed motor angle such that the motor is gradually stopped as it approaches the mechanical stop.

16. The method of claim 15, further comprising:
controlling the motor to follow the target orientation when the sensed angular position is within a nominal angle range in between soft stop boundaries.

17. The method of claim 15, wherein controlling the motor comprises:
receiving, by an orientation sensor, the target orientation, the sensed motor angle, and a sensed camera orientation of a camera attached to the gimbal arm;
generating, by the orientation sensor, an initial target motor rate for causing the motor to move to the camera from the sensed camera orientation to the target orientation based on the sensed motor angle;
combining, by a combiner, the initial target motor rate with a motor rate adjustment signal to generate an adjusted target motor rate; and
generating, by a soft stop module, the motor rate adjustment based on the sensed motor angle.

18. The method of claim 17, wherein controlling the motor further comprises:
generating, by a rate controller, a current control signal based on the adjusted target motor rate; and
generating, by a current controller, a power current for driving the motor based on the current control signal.

19. The method of claim 17, further comprising:
generating a soft stop signal indicating whether the sensed motor angle is within the soft stop region;
detecting when the sensed motor angle remains within the soft stop region for a predefined time length;
asserting, by a flip module, a flip signal in response to the sensed motor angle remaining in the soft stop region for the predefined time length; and
causing the orientation controller to rotate the target orientation by a predefined angle when the flip signal is asserted.

20. The gimbal of claim 17, wherein generating the motor rate adjustment comprises:
varying the motor rate adjustment exponentially with respect to the sensed motor angle as the sensed motor angle approaches the mechanical stop.
